(19) United States
(12) Patent Application Publication
(10) Pub. No.: US 2004/0167944 A1
(43) Pub. Date: Aug. 26, 2004

(54) Control method of data life cycles in knowledge management

(76) Inventor: Hui-Chuan Lin, Taipei (TW)

Correspondence Address: BIRCH STEWART KOLASCH & BIRCH, PO BOX 747, FALLS CHURCH, VA, 22040-0747, US

(21) Appl. No.: 10/372,839

(22) Filed: Feb. 26, 2003

(51) Int. Cl. G06F 12/00; G06F 17/30

(52) U.S. Cl. 707/206

(57) ABSTRACT

A control method of data life cycles in knowledge management selects suitable media and locations to store the data, and changes users' access authority according to the characteristics, versions, key words and summaries of the registered data provided by database maintainers, and the changes of the data life cycles. Therefore, it provides a more economic and efficient way to achieve the object of data management and maintenance.

### BACKGROUND OF THE INVENTION

1. Field of Invention

The invention is a control method of data life cycles in knowledge management, relating especially to those methods of data storage and access based on the data life cycles in knowledge management.

2. Related Art

Knowledge is an important source of competitiveness of an enterprise. In the current labor-centric industrial development phase, only by gathering sufficient manpower can product development be achieved. When entering the capital and technology-centric industrial development phase, the most important management task is to properly utilize the effect of capital and technology in order to obtain the most advantages for investors. Given the trend that a knowledge-based economy is becoming the major development direction of the industry in 21 century, how to make knowledge management more productive is the most important task in this century. Management of the transformation and spread of employees' knowledge is of great importance in knowledge management. In the meantime, since the network is widely used, how to exchange employees' knowledge is the key point of knowledge management that an enterprise should consider in the near future.

How can we exchange employees' knowledge? “Knowledge” is a kind of valuable information reflected in or composed by human minds. Since it cannot be easily structured or directly obtained by machines and analysis, it is usually implicit and not transformed easily. As a result, the essence of knowledge is difficult to be transformed and spread. In view of this, the best strategy of knowledge management of an enterprise is to further transform and spread the links between knowledge structures. The most important ones among these links are data and information.

“Data” is the result of the quantification of the observed events. It can be easily structured and obtained from machines. It is usually quantified and can be transformed or merged into other kinds of data easily. On the other hand, “Information” is the data with a specific relation and object. The process of information generation involves analyzing the contents of the data using analysis tools in order to achieve some meaningful goals. Therefore, data is the basis of knowledge in the process of the transformation of data, information and knowledge.

The task of knowledge management requires transforming data into information, and then internalizing the information into knowledge. However, with the growth of the quality and the quantity of data, how to store this massive amount of data and how users can effectively retrieve the required data from a huge database become severe challenges for database maintainers.

In the meantime, the following practical problems, which usually result from the flow of data, make data maintenance more difficult.

Wasting too much time in the spread and delivery of data.

It is difficult to maintain and control revisions.

Wasting resources in the main memory, hard disks and the backups of hardware in personal computers. (For example, the same data may be replicated in different storage, wasting storage space.)

Wasting time to search for data (for example, users do not know who owns the data and where the data is placed.)

Spending too much time organizing documents. (For example, one must spend time recording and organizing a document upon receipt, which will be used only once.)

It is difficult to decide whether the data should be deleted. (For example, one should consider the life cycles of the data and whether the data will be used in the near future.)

There are various formats of data including texts, voices, videos, images and other hybrid formats. These are also different from one another in the storage media. For example, text can be published in paper and voice can be stored in CDs or tapes. Moreover, hard disks in personal computers can store various formats of data, and are able to provide search engines to users for fast access.

The prices of the media storing the data and the locations for storing the data affect the cost of the data storage. For example, some data can be stored on paper and placed in a basement. Or, they can be stored on microfiche and placed in a temperature, humidity-conditioned space. Therefore, there can be a huge difference among storage environments.

However, is it necessary to store all of the data? The object of storing data is to enable users to approach, obtain, refer to and apply the data when they have the authority. Data has another important characteristic, that is, the number of references to the data is inversely proportionate to the age of the data. In other words, people do not refer to old data as the input of analyses. The recent growth of the amount of data directly increases the load of database maintainers. Therefore, in knowledge management, it is necessary to develop an efficient data management mechanism to effectively link data, information and knowledge.

### SUMMARY OF THE INVENTION

The invention is a control method of data life cycles applied in knowledge management.

Its object is to provide a more economic, efficient way to manage and maintain data. The proposed method of the invention selects suitable media and places to store the data, and changes the access authorities of users in accordance with the characteristics, versions, key words and summaries of the registered data provided by database maintainers, and the changes of the data life cycles.

The invention is a control method of data life cycles in knowledge management. It selects a suitable data maintenance method in accordance with data life cycles. Therefore, it provides a more economic, efficient way to achieve the object of data management and maintenance. For database maintainers, there is a tradeoff between providing a largest knowledge management database to the users and reducing the storage cost of the database.

The efficiency of access and queries for the data in short-term life cycles is important. Hence, selecting a suitable place to store the data can improve the efficiency of data access and query. For data in mid-term life cycles, the cost of media storage should be a concern. Since the probability of access and query of the data is lower than that of the data in short-term life cycles, storing the data in a cheap medium reduces the load of data maintenance and only affects the convenience of a few users. When entering the long-term life cycle, the data may be deleted and the cost of data maintenance is reduced. Otherwise, storing this data in cheap storage will also reduce the cost of database maintenance.

### BRIEF DESCRIPTION OF THE DRAWINGS

The invention will become more fully understood from the detailed description given hereinbelow illustration only, and thus are not limitative of the present invention, and wherein:

FIG. 1 shows a system flowchart of the invention.

FIG. 2 shows a flowchart of the operation of data registration of the invention.

FIG. 3 shows a flowchart of the operation of data life cycle determination of the invention.

FIG. 4 shows a flowchart of the operation of data maintenance of the invention.

FIG. 5 shows a flowchart of the operation of data control of the invention.

### DETAILED DESCRIPTION OF THE INVENTION

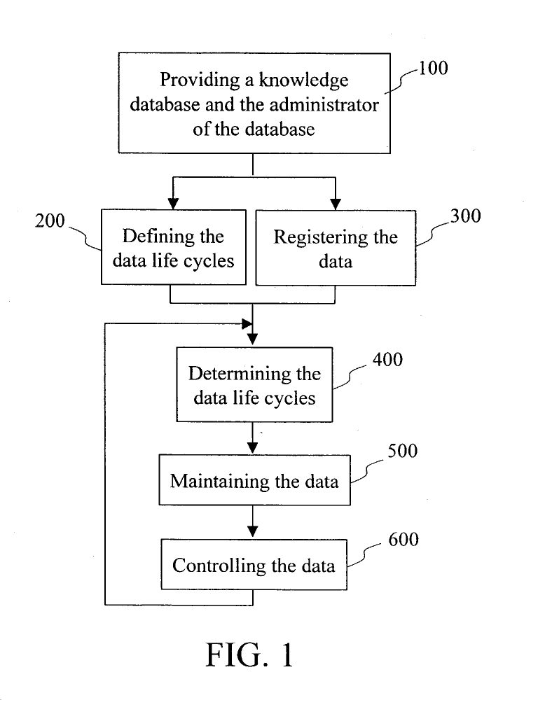

FIG. 1 shows the system architecture of the invention. A control method of data life cycles in knowledge management proposed by the invention comprises the following steps:

a. Providing a Knowledge Management Database and the Maintainers of the Database (Step 100):

The first stage to implement the proposed control method is to setup a knowledge management database, and employ database maintainers to take charge of the operation of the database.

b. Defining the Data Life Cycles (Step 200):

Defining the data life cycles is to define the periods of the short-term, mid-term and long-term life cycles of the data according to the characteristics of the data (for example, the data may be a tendency report, an introduction of technology, a detailed, professional description of technology or a memo of an enterprise). For example, the short-term life cycle of a tendency report can be defined as six months, one or two years. The short-term life cycle of professional technology data may be defined as one, five or ten years. Therefore, the periods of all data life cycles are defined based on the characteristics of the data. The data life cycles are defined because in addition to the relationship between the data the subject, the time interval between the current time and the occurrence time of the data is also an important basis for the users to refer to the data. For an event that recently occurred, consider a reference to a similar, old event. The older the referred event is, the lower the value of the reference. Take the knowledge of integrated circuit technology as an example. The data concerning transistors had a strong relationship with integrated circuits forty or fifty years ago. However this data has a weak relationship with the latest integrated circuit technology. From the users' perspective, defining the data life cycles, which allows for up-to-date data related to the subject, is an effective data provision method.

c. Registering the Data

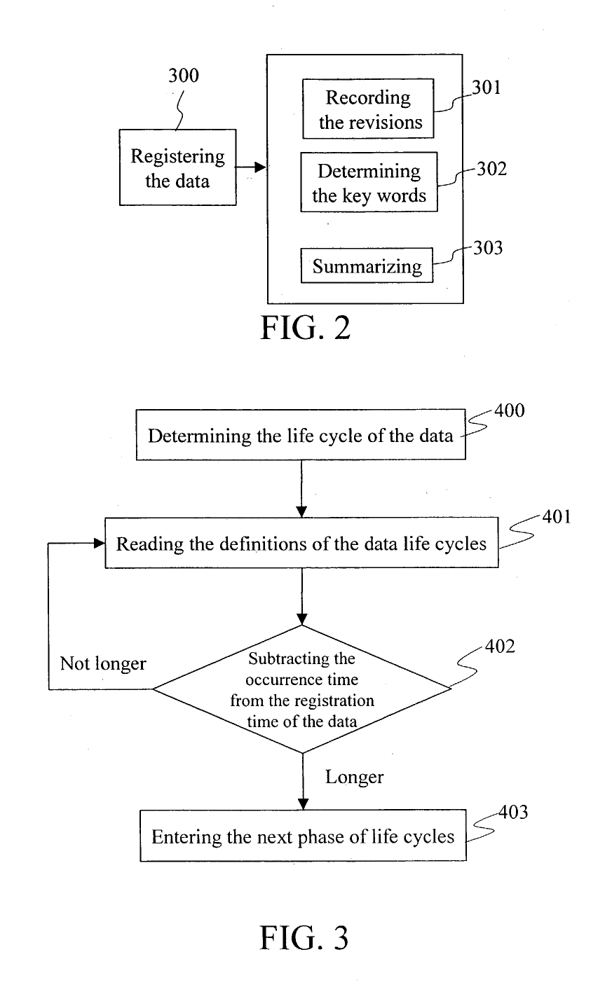

Registering the data means that the database maintainers provide a database and register the data into the database. The database maintainers will define the formats and contents of data registration by themselves according to the requirements for access and storage. FIG. 2 shows a flowchart of the operations of data registration of the invention. The operations of data registration comprise the following three steps: recording the revisions (step 301), determining the key words (step 302) and summarizing (step 303). Recording the revisions is to recode the time information and the number of revisions of the data. The time information comprises the occurrence time, the registration time and the definition of the life cycle of the data. Note that both the occurrence and registration times are important bases to determine the data life cycles. The definition of the life cycle of the data is the specification of the data life cycles assigned to the data according to the characteristics of the data (for example, the data may be a tendency report or a detailed, professional description of technology). In addition, the data with more revisions is more up-to-date than that with fewer revisions.

Key words, which are the bases of users' queries, comprise the key words of subjects, authors, events and integrated information. Summarizing allows the users to quickly determine whether the retrieved data is required. The methods of summarizing involve: referring to the existing summaries, manual summarizing by database maintainers, capturing the first paragraph of the data, and summarizing by word processors (e.g., Word of Microsoft) automatically.

d. Determining the Data Life Cycles

Determining the data life cycles is to determine the life cycle of the data by calculating the time interval between the registration time and the occurrence time of the data. Note that the older the data is, the lower the probability that the data is referred to. As a result, the database maintainers should not spend the cost of storing the data that may not be referred to in the future. Hence, the database maintainers have the privilege of providing different storage services to data in difference life cycles.

Database maintainers can set the length of time intervals of life cycles to be fixed, and the data life cycles should at least contain short-term, mid-term and long-term life cycles. The data enters the short-term life cycle after being registered into the database. In addition, the data enters mid and long-term life cycles after fixed time intervals. To determine the life cycles of data, please refer to FIG. 3, which is a flowchart of the operation of data life cycle determination of the invention. The details of the determination are as follows. First, read the definitions of data life cycles (Step 401), which store the version record of the data (Step 301). Then, calculate a time interval by subtracting the occurrence time from the registration time of the data (Step 402), and compare the resulting time interval with the specification of the life cycle of the data. If the time interval is smaller than the specification of the life cycle of the data, the data still stay in the same life cycle. Otherwise, the data will enter the next life cycle (Step 403).

e. Maintaining the Data

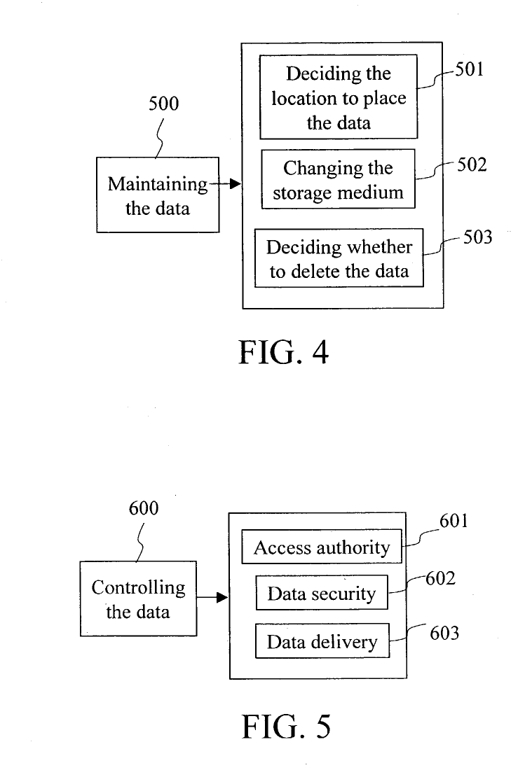

Maintaining the data means that the database maintainers should change the storage status of the data on the basis of the life cycles of the data. FIG. 4 shows a flowchart of the operation of data maintenance of the invention. The operation of data maintenance in a short-term life cycle is to decide where to store the data (Step 501). Since the data was produced recently, it is most likely to be noticed and referred to. Therefore, deciding a suitable place to store it makes accessing the data more efficient.

The operation of data maintenance in mid-term life cycles is to determine the medium in which to store it (Step 502). Since the data was produced some time prior, the reference probability decreases drastically. Therefore, the database maintainers should move the data to another cheaper storage medium. Although the access to and queries of these kinds of media are usually complicated and inefficient, the influence on the users' convenience is limited due to the low reference probability.

The operation of data maintenance in long-term life cycles is to decide whether to delete the data permanently. Since the data was produced a long time prior, most people forget it, and the reference probability of the data may approach zero. As a result, the database maintainers should decide whether to delete the data permanently. If the database maintainers think that the data has some important uses and should be stored, the data is stored in a cheap medium permanently.

f. Controlling the Data

Controlling the data means that the database maintainers change the data access properties according to the life cycles of the data. FIG. 5 shows a flowchart of the operation of data control of the invention. Data access properties control comprises the changes of the access authorities, data securities and data delivery. Generally speaking, the degree of importance and confidentiality of the data drastically changes with the change of people, events, time, places and objects. For example, particular research data is no longer confidential after the related product has been finished or patent filed. The importance of the data also decreases as time goes by. Therefore, database maintainers have the privilege of changing the access properties of the data based the life cycle of the data (Step 601). For example, the access authority for users of data can be relaxed in mid-term or long-term life cycles. The access authority for some data with security concerns can also be relaxed (Step 602) in mid-term or long-term life cycles. Moreover, the delivery of data that used to be delivered in a controlled way can be changed (Step 603) to become more efficient.

g. Iteration

As time goes by, all data passes through short-term, mid-term and long-term life cycles. The data enters the short-term life cycle when the data is just registered. For the data in short-term life cycles, iteration means that there will be changes in the data maintenance and control when the data enters the mid-term life cycles. For the data in mid-term life cycles, iteration means that there will be changes in the data maintenance and control when the data enters the long-term life cycles. In addition, the database will close the services of the data when the database maintainers decide to delete the data. If the database maintainers decide to store the data permanently, the data will be permanently stored in a cheap medium for users' access and queries.

What is claimed is:

1. A control method of data life cycles applied in knowledge management comprising:
a. providing a knowledge management database;
b. defining the specifications of the data life cycles according to the properties of the data;
c. Registering a data into the knowledge management database on the basis of the properties of the data;
d. comparing the current time with the data registration time for determining in which stage the data life cycles of the registration data is;
e. maintaining the storage type of the data according to the stage of the registration data; and
f. controlling the retrieving type of the data according to the stage of the registration data.

2. The method of claim 1, wherein the data life cycle is a fixed cycle.

3. The method of claim 2, wherein the fixed cycle at least is one selected from the group consisting of a short-term data life cycle, a mid-term data life cycle, and a long-term data life cycle.

4. The method of claim 1, wherein the properties of the data comprises a version of the registration data, key words of the registration data, and a abstract of the registration data.

5. The method of claim 4, wherein the version of the registration data comprises a time of the registration data, and a number of the version.

6. The method of claim 5, wherein the time of the registration data at least comprises a occurrence time and a registration time.

7. The method of claim 4, wherein the key words of the registration data which is taken as the basis of queries are one selected from the group consisting of a subject, a author, and a event.

8. The method of claim 4, wherein the abstract of the registration data is generated by referring to the existing abstract.

9. The method of claim 4, wherein the abstract of the registration data is generated by the administrator of the knowledge management database.

10. The method of claim 4, wherein the abstract of the registration data is generated by retrieving the first paragraph of the data.

11. The method of claim 4, wherein the abstract of the registration data is automatic generated by word processors.

12. The method of claim 1, wherein the step (e) is to decide the data storing location when the data is in the short-term data life cycles.

13. The method of claim 1, wherein the step (e) is to change the data storing media when the data is in the mid-term data life cycles.

14. The method of claim 1, wherein the step (e) is to decide whether to delete the data when the data is in the long-term data life cycles.

15. The method of claim 1, wherein the step of controlling the retrieving type of the data is to change the access authority, data security and the data delivery authority when the stage of the life cycles of the data changes.
